(19) United States
(12) Patent Application Publication
(10) Pub. No.: US 2006/0080139 A1
(43) Pub. Date: Apr. 13, 2006

(54) Preadmission health care cost and reimbursement estimation tool

(75) Inventor: Richard Mainzer, Bowie, MD (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Woodhaven Health Services

(21) Appl. No.: 10/960,758

(22) Filed: Oct. 8, 2004

(51) Int. Cl. G06Q 50/00

(52) U.S. Cl. 705/2; 705/4

(57) ABSTRACT

A cost estimation tool, preferably a handheld computer, prices and evaluates the financial impact of new residents' prior to admission. Immediate access to this information and built-in therapeutic substitution and clinical advisories provides the opportunity to optimize pharmaceutical regimens prior to admission. In addition, an abbreviated Resource Utilization Group (RUG) evaluation function provides a rapid assessment tool to project reimbursement under the Medicare Prospective Payment System (PPS). A user may enter a complete drug regimen and estimate the costs for the regimen. Similarly, managed care reimbursement from managed care organizations (MCOs) to be analyzed. Also, drug cost may be estimated through a MEDICAID Preferred Drug List database that identifies potential Non-Preferred drugs that may be non-compensable. The present invention further transmits results wirelessly to health care providers.

### CROSS-REFERENCE TO RELATED APPLICATIONS

Not Applicable.

### STATEMENT REGARDING SPONSORED RESEARCH OR DEVELOPMENT

Not Applicable.

### REFERENCE TO SEQUENCE LISTING

Not Applicable.

### BACKGROUND OF THE INVENTION

### DISCUSSION OF RELATED PRIOR ART

With rising health care costs, it is imperative that health care providers provide health services efficiently and cost effectively. At the same time, the administrative demands of medical record keeping, billing and managing a medical practice have become more burdensome. In particular, health care providers must be thorough and keep detailed records of medical exams to accurately document observations and services that have been provided.

When checking into a medical facility, patients generally must provide personal information and payment reimbursement information, and various known technologies assist health care providers in this task. The patients' personal information is used to identify and track the patient, along with assisting the health care providers to provide appropriate care. The health care provider uses the payment reimbursement information to request payment through appropriate insurance and government programs. Various known software applications further automate the submission and processing of medical payments. However, the known technology does not address the needs of cost estimation at check-in based upon the provided information. Furthermore, the known applications do not address continued cost monitoring and cost control based upon the information provided at check-in.

Several known patents related to computerized patient care and cost estimation are now summarized. In one type of known systems, such as U.S. Pat. No. 6,671,563 issued to Engelson, et al., entitled SYSTEM AND METHOD FOR COLLECTING DATA AND MANAGING PATIENT CARE, provides a care management system in which the management of the administration of care for patients is automated. Hospital information systems are monitored and the information from those systems is used in verifying the administrations of care to patients. The care management system monitors ongoing administrations for progress and automatically updates records and provides alarms when necessary. The care management system is modular in nature but is fully integrated among its modules. Particular lists of data, such as the termination times of all ongoing infusions, provide hospital staff current information for increased accuracy and efficiency in planning. Features include the automatic provision of infusion parameters to pumps for accurate and efficient configuration of the pump, and providing an alarm when an unscheduled suspension of an infusion exceeds a predetermined length of time. A passive recognition system for identifying patients and caregivers is also provided. However, these system address the tracking of patient care once admitted and do not address cost estimation at check-in or cost control based upon the information provided at check-in.

Another known technology estimates a cost for each type of injury or illness and then attempts to limit actual payments based upon the costs based upon the generic cost estimate. For example, U.S. Pat. No. 6,324,516 issued to Shults, et al., entitled SYSTEM AND APPARATUS FOR UTILIZATION REVIEW OF MEDICAL CLAIMS provides a medical cost containment system for ensuring that the anticipated cost savings from utilization review (UR) agreements are actually realized. The UR agreements are essentially contractual agreements that specify the type and quantity of medical treatments relating to a specific claim resulting from a specific injury. Each UR agreement comprises a claim number, a procedure code describing the particular medical service authorized, and some indication as to dates or quantity of service authorized. All of the UR agreements are stored in a UR database. When a medical bill is received by the insurance company, the bill is entered into the computer. The cost containment system searches all UR agreements in the UR database which have the same claim number as the claim number on the bill. For each item in the medical bill, the system finds the UR agreement which most closely matches the procedure code in the line item and various other criteria, such as the dates of treatment. The system then checks to ensure that the item in the bill is authorized by the UR agreement. If the item is authorized, then payment is made, and if the item is not authorized, then the item is flagged for further review. It should be appreciated that this type of application merely attempts to estimate and enforce general cost estimates that do not vary by patients. Different patients have differing needs. Furthermore, different patients have different payment rules according to various insurance coverages and eligibility for various government programs. However, these known cost estimation tools merely define and enforce a coverage cap that is not tailored to individual patients. Furthermore, these known cost estimation tools merely provide a cap that does not provide any assistance to health care providers in managing and lowering costs.

These limitations are especially important in extended care, such as nursing homes. In extended care, the health care providers are faced with multiple treatment and care decisions, with the different decisions having varying implications to the patients. Furthermore, the payment rules and regulations of various insurance and government programs are quite complex and difficult to administer. For example, a patient's insurance may not pay for certain types of medical treatments, and patient should ideally be notified of potential non-reimbursed treatments costs. To further complicate matters, other health care-related decisions may have important, unpredictable costs implications to patients. For example, various complex payment rules dictate reimbursements for the type of accommodation (e.g., private versus shared rooms) or other health related services such as physical therapy.

### SUMMARY OF THE INVENTION

In response to these and other needs, a computer implemented system and related method provide long term care nursing facilities with the ability to proactively evaluate new or prospective residents' drug therapies and identify high cost drugs, important clinical information and possible therapeutic alternatives. In addition, an abbreviated Medicare RUGs III grouper provides an opportunity to estimate resident reimbursement under the Medicare Part A prospective payment system (PPS) once facility-specific cost information is entered into a user profile created in the present invention. The ability to obtain this information immediately is important in the admission process so that potential clinical and cost savings issues may be resolved as early as possible.

In a preferred implementation, the cost estimation tool of the present invention is a handheld computer or PDA-based technology that gives long term care admission directors and hospital based assessment coordinators the ability to price and evaluate the financial impact of new residents' drug therapies prior to admission. Immediate access to this information and built-in therapeutic substitution and clinical advisories provides the opportunity to optimize pharmaceutical regimens prior to admission. In addition, an abbreviated Resource Utilization Group (RUG) evaluation function provides a rapid assessment tool to project reimbursement under the Medicare Prospective Payment System (PPS).

The cost estimator contains a complete pharmacy drug file with facility-specific pricing, thereby allowing instant access to pricing of all drugs and eliminating the need to contact pharmacy for quotes.

The present invention further allows a user to enter a complete drug regimen allows the user to evaluate the drug cost component of an average MEDICARE Prospective Payment System (PPS) daily reimbursement or a selected RUGs III group. The PPS rates will be customized to a facility and profitability may be pre-determined. This feather reduces the risk of costly admissions and increases the opportunity to take patients previously avoided.

Embodiments of the present invention further allow Managed Care reimbursement from managed care organizations (MCOs) to be analyzed in a similar fashion, thereby, increasing provider revenues and improving negotiations with payors (the MCOs).

Embodiments of the present invention further allow the user to estimate drug costs through the use of a MEDICAID Preferred Drug List database that identifies potential Non-Preferred drugs that may be non-compensable.

Embodiments of the present invention allow a user to view drug costs for an estimated length of stay or per patient day. Embodiments of the present invention further offer recommendations for cost effective drugs.

Embodiments of the present invention further allow the results from the cost estimation to be beamed to a mini-hand held printer or other output device for requesting changes from the physician or as a record for follow-up. Similarly, results may also be saved to memory and downloaded to another computer for review and/or printing at a later time. Embodiments of the present invention further allow the results may be transmitted wirelessly. This feature Reduces nursing time for changes in drug therapy especially with new formulary requirements and speeds up admission process. Overall, this improves documentation of admission and decision process

### BRIEF DESCRIPTION OF THE DRAWINGS

A more complete understanding of the present invention and advantages thereof may be acquired by referring to the following description taken in conjunction with the accompanying drawings in which like reference numbers indicate like features, and wherein:

FIGS. 1-6 and 7A-B depict screenshots from a health cost estimation tool in accordance with embodiments of the present invention;

FIGS. 8-15 depict screenshots from a RUGs grouping estimation tool used in a health cost estimation tool in accordance with embodiments of the present invention;

FIG. 16 depicts a health cost estimation tool in accordance with embodiments of the present invention; and

FIG. 17 depicts the steps in a pre-admission costs estimation method in accordance with embodiments of the present invention.

### DETAILED DESCRIPTION OF THE PREFERRED EMBODIMENTS

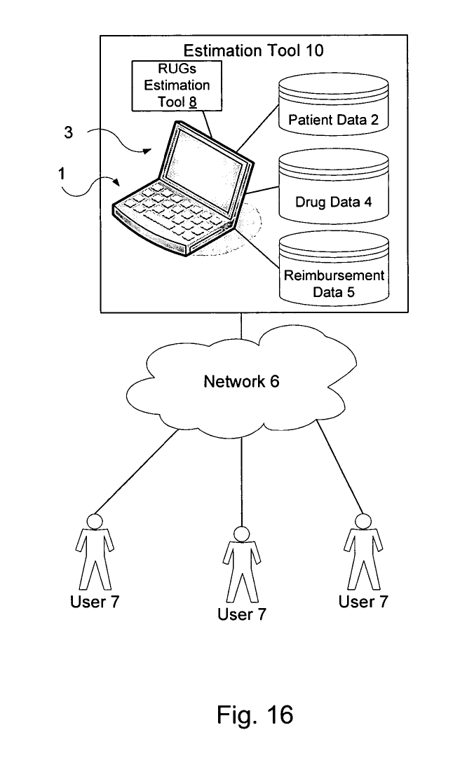

FIG. 16 depicts the components in a cost estimation tool 10 for estimating costs for a patient receiving a course of treatment. The cost estimation tool 10 generally includes an input device 1 for accepting data from a user, and this input data is stored in an input database 2 for use with other components. The cost estimation tool 10 further includes an output device 3 for prompting the user for data and for displaying results. Data on various treatments and medication is contained in a treatment database 4. The treatment database 4 contains, for example, information on various drugs including the name and dosages of the drugs, cost and size per purchasable unit of the drug. Similarly, reimbursement rules and requirements for various insurance and government programs are contained in a reimbursement database 5. The reimbursement database 5 usually specifies the various reimbursement amounts for each of the treatments to patients.

In operation, a user accesses the cost estimation tool 10 and provides information on the patient and the proposed course of treatment through the input device 1. The cost estimation tool 10 accepts and displays these inputs in output device 3. If needed, the user may access the treatment database 4 when defining the course of treatment. As described in greater detail below, after the user defines the course of treatment, namely the drugs and dosage model for the patient, the cost estimation tool 10 accesses the treatment database 4 to determine an overall and daily cost for the patient. The cost estimation tool 10 may further access the treatment database to determine preprogrammed alternative treatments to the course of treatments and to determine the cost implications of the alternative treatments. The user may then modify the course of treatment to incorporate the suggested alternative treatments. Once a course of treatment is finalized, the cost estimation tool 10 may access the reimbursement database 5 to determine likely reimbursements for cost associated with the final course of treatment.

The cost estimation tool 10 may further include a RUGs costs estimator 8. As described in greater detail below, the RUGs costs estimator 8 walks a user through a series of questions for accessing the care level required for a prospective long-term care patient. The questions generally address the patient's general level of wellness, and predicts the amount of reimbursement to be received from Medicare, which offers differing reimbursements levels based upon the care level required for the patient.

The Cost estimation tool 10 is preferably a handheld computing device such as a Palm® or a PocketPC® that allows a intake official at a health care facility to systematically interview a perspective patient and to determine likely costs and reimbursements for that patient.

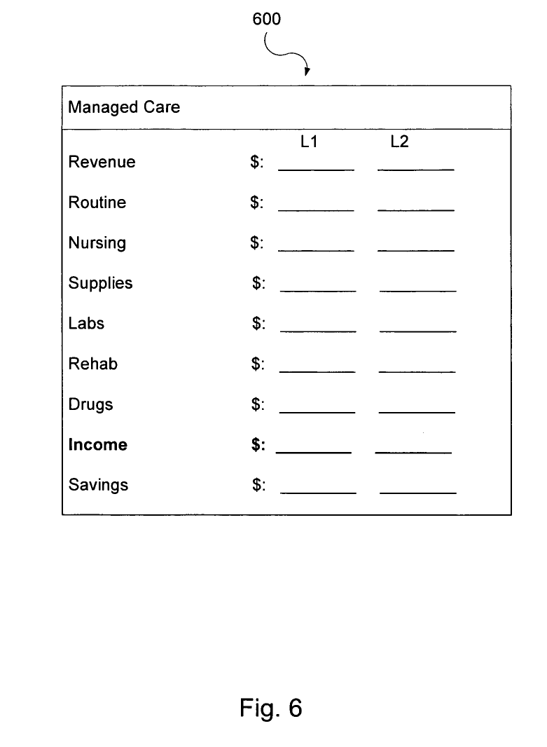

Continuing with FIG. 6, the cost estimation tool 10 may further operate to transfer the course of treatment and associated cost and reimbursement findings through a network 6 that allows others to access the cost estimation results. The cost estimation tool 10 may then transmit the course of treatment and the associated costs finds to other users 7, such as care providers. In one embodiment, the network 6 may be a wireless communications or data network that allows the transfer of the patient, drug, and reimbursement data 2, 4, and 5 to the other users 7. The users 7, such as doctors or other health care provides, can use this information to properly provide care to the patient. This functionality allows the providers 7 to be conscientious of patient costs when administering care. For example, a patient's insurance may pay for one type of antibiotic but not an equivalent form, and this information would allow the health care provider to select the appropriate form in order to minimize costs to the patient.

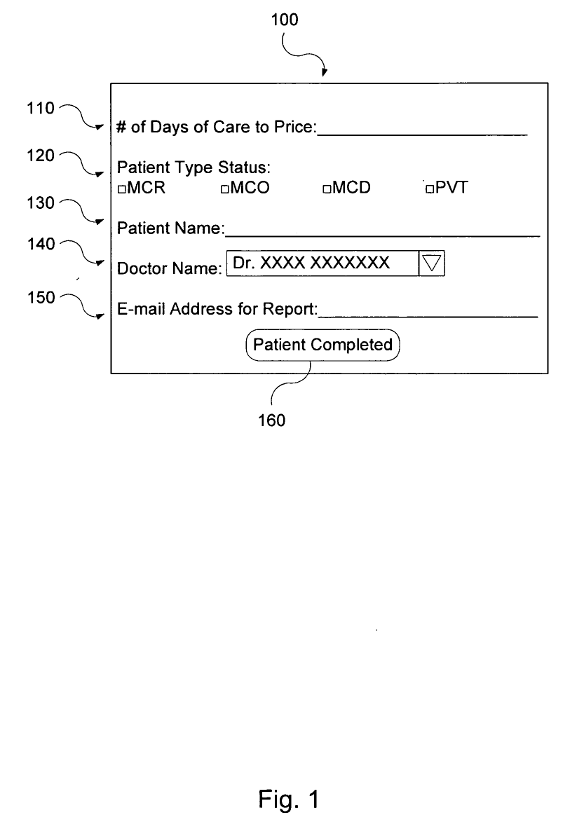

Turning now to FIGS. 1-5, the health cost estimation tool 10 of the present invention generally operates through a series of visual displays requesting input data and presenting various data in response. In particular, the health cost estimation tool 10 of the present invention collects various information about a patient and that patient's cost coverage by insurance and government programs. This information can then be used at check-into predict these third party reimbursements. These reimbursements prediction can then be used to predict expected costs to the patient. The information can further be used during the stay so that treatment decisions can be made in view of the reimbursements prediction and requirements.

After logging into the tool 10, generally by providing an identifier and password, a user is taken to a general data collection screen 100, as depicted in FIG. 1. The general data collection screen 100 presents various general questions as needed to identify a patient and to direct later data collection screens, described in greater detail below. Among the display components of the general data collection screen 100 include a data field requesting the number of days to price, field 110. The number of days 110 is generally based on the patient's expected length of stay (LOS) in the facility.

Continuing with FIG. 1, the general data collection screen 100 further includes a patient pay type status field 120 the summarizes the patient's coverages. For example, the displayed patient pay type status field 120 in FIG. 1, includes checkboxes for Medicare (MCR); Managed Care (MCO); Medicaid (MCD) and Private (PVT) options that may be selected by tapping the box to the left of each pay type. The selection of a pay type field 120 leads to different coverage estimators and requirements that are specific to that payer (e.g., Preferred Drug List [PDL] for Medicaid; Resource Utilization Groups [RUGS], version III payment system of resident classification used under SNF PPS for Medicare; or Managed Care analysis for MCO). Selection of MCO in the patient pay type status field 120 brings up another display to select a specific MCO plan.

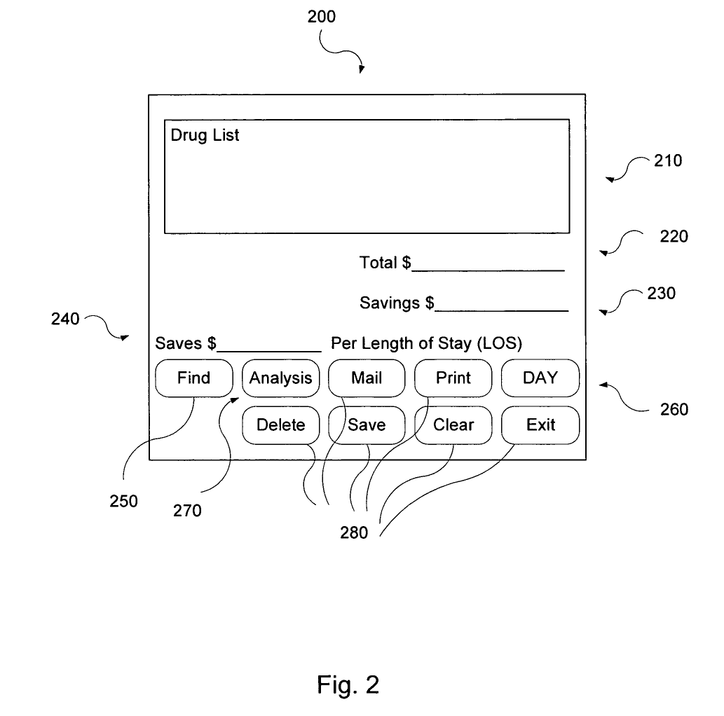

The general data collection screen 100 further includes a Patient Name field 130 that allows a user to specify the patient's name or other identifier to be used by the health care facility. For example, a name, number, pseudonym or other identifier may be added in the patient name field 130 if the screening information is saved or printed for later review. Ideally, the information can be communicated in real-time to the hospital or referral staff for immediate action. Similarly, in field 140, the user may specify the name of doctor or doctors expected to care for the patient. As displayed in the general data collection screen 100 of FIG. 1, the user may tap the small triangle to the left of the name to select from a drop down list of doctor names. The general data collection screen 100 may further include an E-Mail Address input field 150. The e-mail field 150 identifies the destination e-mail address for pricing and analysis reports to be sent directly to the doctor or other individual, as described above. Once the fields in the general data collection screen 100 are completed, the user may then tap a Complete Button 160 to save the input data and to continue to later screens, such as those depicted in FIGS. 2-5.

The user is then present with a cost estimation screen 200 in FIG. 2. Specifically, cost estimation screen 200 allows the user to specify various drugs and to estimate the costs to the patient for these drugs, based upon the information provided previously in the general data collection screen 100. It should be appreciated that while the below discussion focuses on drugs, similar techniques could likewise be used to define and price various medical procedures and other health-related items. In the cost estimation screen 200 in FIG. 2, the user may manually provide data in the drug list 210 to define the expected drug costs to a user, and then the expected reimbursements for these costs are calculated. The user provides sufficient information to price the drugs to be given to a patient during her stay in the medical facility. Typically, the information provided by the user to drug list 210 may includes a Drug Name; a Drug Strength (e.g.,mg, mcg, gm, %, etc.); a Drug Dosage Form (e.g., tablet, capsule, liquid, injection, etc.); a Dosage Amount (e.g.,how many tablets, ml's, gm's, etc. per administration of the drug); a Frequency (how many of the above DOSES are given each DAY); and a Days of Therapy or duration or the doses. The user may administer the drug selections in the cost estimation screen 200 through various administrative commands 280.

It should be appreciated that the user can make an initial estimate of the various values in the drug list 210, and that these values may later be adjusted as doctors update the patient's course of treatment. In this way, the price forecast may be updated according to changes in patient care.

Continuing with the cost estimation screen 200 in FIG. 2, the total cost for all of the prescribed medication is automatically summed and presented as a total 220. A calculation of a savings values associated with the course of treatment is then automatically presented as savings 230. As described in greater detail below, the saving value 230 represents the different costs associated with a drug selections, and a total saving 240 represents the savings over the LOS from all of the drug decisions. A total saving field 240 then represents the total savings to the patient over the LOS.

Continuing with FIG. 2, in some instances, it may be useful to evaluate the cost of drug therapy for each day of care. This feature is especially valuable when considering fixed daily reimbursements from Medicare or Managed Care. If the user may select Day button 260, the saving value 230 is then divided by the LOS to find an average daily savings.

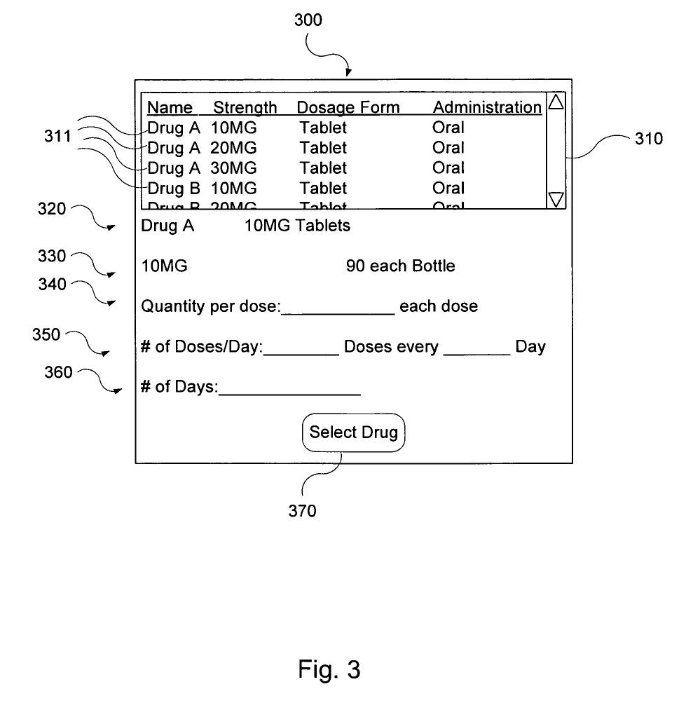

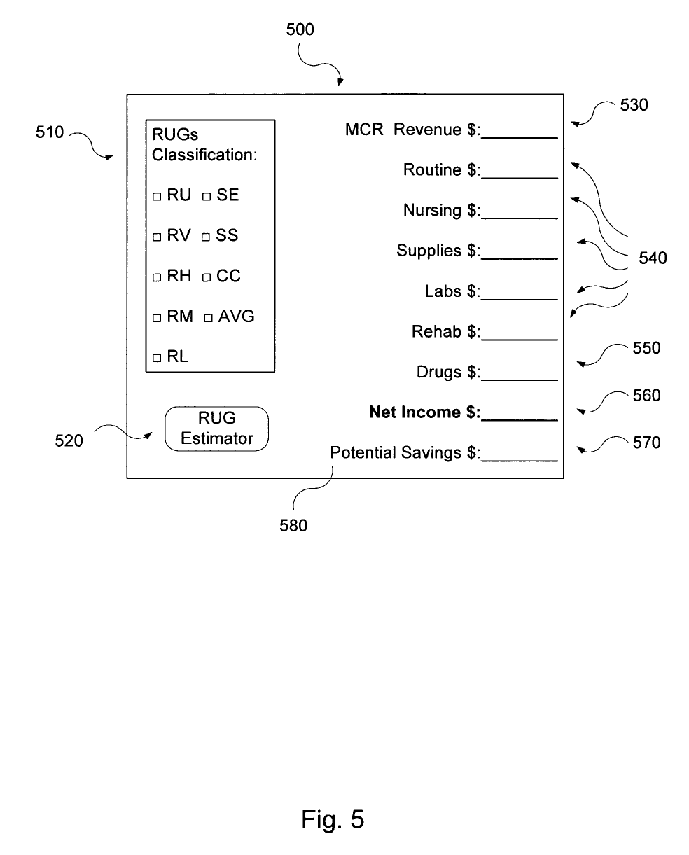

Once the user has completed entry of the drug information, the user may select an Analysis button 270 to request an automated report to estimate reimbursement for the specified drugs. The Analysis operation is described in greater detail below in association with FIG. 5. The purpose of this analysis is to provide a rapid overview of the drug component's impact on reimbursement. Furthermore, the facility-specific cost components (e.g., nursing, supplies, rehab, etc.) may be customized within the facility. The purpose of the drug cost reimbursement analysis is to offer the facility an opportunity to admit residents with a full understanding of the costs associated with their drug therapy. Identifying opportunities to reduce these costs may allow the admission of residents with a more cost effective drug regimen. It may also help to dispel myths about drugs that have previously been perceived as “too expensive”, such as IV medications since a short term IV antibiotic spread over the length of stay may not be any more expensive “per patient day” than many ordinary oral medications. Specifically, with fixed reimbursement mechanisms, complex Medicare and Managed Care scenarios can be further analyzed.

Where the user does not know the information needed for the drug list 210, the user may select the Find button 250 in order to select from pre-existing lists of drugs. Turning now to FIG. 3, a Find Drug screen 300 is presented. The Find Drug screen 300 includes drug menu 310 listing one or more drug entries 311. These entries may be organized and accessed as known in the field of computer science. For example, the drugs may be listed by category, by name, or by primary use. The displayed drug menu 310 lists drug entries 311 associated with two different drugs names (Drug A and Drug B). Different drug entries 311 for the same drug may be needed because the same drug is often available in different strengths or dosage forms. The displayed drug menu 310 in FIG. 3 also lists an administration type (e.g., oral, in comparison to injection, intravenous, or topical application) so that the user may use this information in selecting an appropriate drug for the patient.

The user may search through the drugs contained in the drug menu 310, and selecting drugs for pricing. The user may select one of the drugs entries contained in the drug menu 310, and this selection is display as selected drug 320. Typically, the displayed selection field shows the name of the drug and the Drug Strength and/or physical form of the named drug.

The drug menu 310 represents an extensive searchable database of drugs. For example, the drug menu 310 may present an alphabetical listing of drugs, and the user may scroll through the drug menu to locate a desired drug. Because the drug menu 310 is generally limited in size, the user can only view several drug listings 311 at a time. To narrow the list of drugs included in the drug menu 310, the user may provide drug-identifying information such as the first few letters of the drug name to be priced. The drug list 310 then only displays drugs conforming to the drug-identifying information. If there are multiple listings for a drug (different strengths, dosage forms, etc), the user may use the UP and DOWN ARROWS located to the right of the drug list. This way, the drug menu 310 allows the user to scroll up and down through the drug listing until the user locates the needed product. The drug menu 310 may further optionally expanded information about each drug in response to a user's requests, as needed to determine if the user has found the correct product. For example, a drug entry 311 may be linked to further information about the drug, including its uses, side effects, and interactions with other medication

After the user has located a desired medication, the user highlights this drug and adds the drug to the drug list 210 for pricing analysis. Similarly, the user may select and delete a drug in the drug list.

Optionally, the present invention can automatically substitute a generic brand if a brand name product is selected from the drug menu 310. This feature alerts the user that a less expensive, equivalent medicine is available so that the user may compare costs and reimbursements for the different brands. The suggestion of alternative medicine is described in greater detail below.

After selecting the drug, the user completes a “dosing” model through the Find Drug screen 300 to indicate the dose, frequency of use, and length of therapy. After completing this step, the drug is selected, priced, and added to the drug list 210. The “dosing” model implemented through the Find Drug screen 300 of FIG. 3 is now described in greater detail.

The commercially available form of the selected drug 320 is then automatically accessed and provided as commercial form 330. The commercial form 330 represent a minimum required purchase of the selected drug as needed to satisfy the patient's needs. More specifically, medications can only be purchased in certain sizes or configurations, so the patient's drug costs should be calculated from the required purchase amount, even if the patient only consumes a portion of the required purchase amount.

The user then specifies information to customize the drug costs estimate to the particular patient. Specifically, the user may specify a DOSE value 340 to indicate how many units of the selected medication 320 are given to the patient during each administration. Similarly, the user can specify a treatment frequency value 350 and a Days of Treatment value 360. The frequency value 350 represents how many of the DOSES are given each day. In medical notation, the frequency value 350 is typically noted as QD=1; BID=2; TID=3; QID=4, Q6H=4; Q4H=6, etc. The Days of Treatment value 360 represents the duration of the drug treatment. The number of days to price 110 may be automatically inserted as the Days of Treatment value 360, representing a drug administered over the entire duration of the patient's stay. However, the user may change Days of Treatment value 360 for any single drug in the list to reflect the actual duration of the treatment. As described in greater detail below, the cost estimation tool 10, still spreads the costs for the medication throughout the patient's length of stay (LOS) to provide a more accurate daily cost impact, regardless of the Days of Treatment value 360.

In one implementation, the dose value 340 and/or the days of treatment value 360 may be automatically adjusted to consume the entire commercial form 330. This allows the cost estimation tool 10 to reflect the true costs for the drug. For example, the DOSE value 340 may change to 10 ml when selecting a 10 ml bottle of a drug that must be dispensed in its entirety. The user may be alerted of these types of changes to insure that the dosage changes are merely accounting values and not used when administering the medication.

Thus, as each drug is selected and the patient specific details are added through the find drug screen drug 300, the patient specific drug use may be priced and added to the drug list 210.

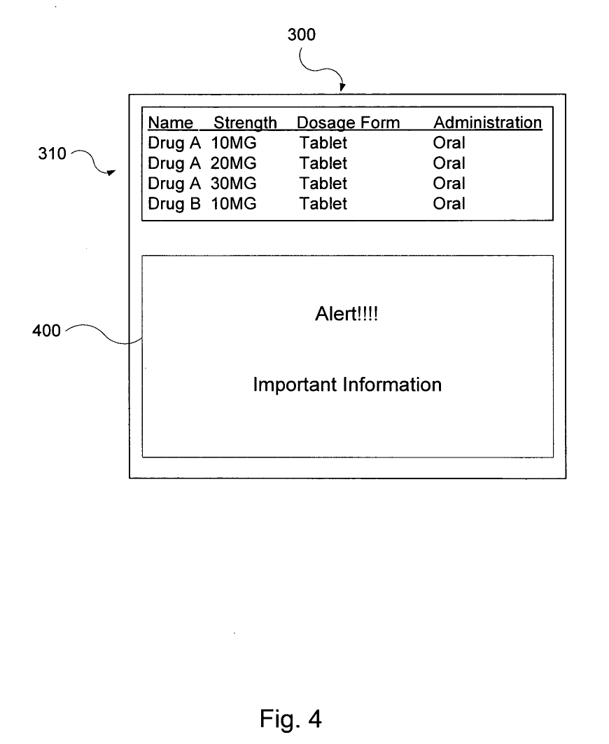

As depicted in FIG. 4, an automated alert 400 may appear based on the users drug selections and other data provided during the drug selection process. The alert 400 is intended to alert the user to a variety of issues such as:
a. Cost-effective alternative drugs or other cost savings measures
b. Regulatory alerts
c. Clinical alerts
d. Reimbursement issues (e.g. Medicaid PDL or Formulary)
   After reviewing the special information, the user may elect to keep the current drug selections selection despite the warning, or the user may return to the drug selection menu 310 and choose a different drug, thereby discarding a currently selected drug choice. The alert message 400 may be color coded as well to indicate to the user the importance of the alert message 400. The information presented in these alert messages 400 is generally based upon prevailing standards, common formulary initiatives, LTC regulations and other resources, and are meant only to provide general pricing advice. A doctor should make the final clinical evaluation and decision before changing any medication orders.

For example, the alert message 400 may suggest an alternative, lower cost drug. The suggestions may be universal in nature or may be customized from a particular facility's drug formulary. Some of these savings involve consideration of alternative drugs. In other instances, the alternative may be as simple as changing to a different form of the same drug (e.g. tablet instead of liquid) or a comparable dose of the same drug that is more cost-effective. As described above, the user may choose to either ignore the alert message 400 or to return to the drug selection screen 200 to select the alternative contained in the alert message. Similarly, the user may return to the drug search screen 300 to modify one or more of the values 320-360. When the user returns to the drug selection screen 200 and selects an alternative drug or changes dosage model values for a selected drug, the savings value 230 represents the difference in cost attributable to this change. Otherwise, the drug selection screen 200 may display potential savings as the user scrolls through the drug menu. For example, the user may see the original drug priced in the drug list 210 with a highlighted area below the list that indicates a suggested alternative and its cost savings potential.

Thus, it can be seen that the cost estimation tool 10 allows a user to select a course of treatment for patient and then price this course of treatment. Specifically, the cost estimation tool 10 allows the user to customize the course of treatment to the user, so that the price estimate is improved. The cost estimation is made in view of real world medical purchasing requirements. The cost estimation tool 10 further identifies possible alternative treatments and provides an accounting price differences for these alternative treatments.

Turning now to FIG. 5, embodiments of the cost estimation tool 10 further analyze the patient data and the selected drug list defined in the cost estimation screen 200 to estimate reimbursements for cost associated with a proposed course of treatments. Specifically, the user may request this reimbursement analysis by selecting the analysis button 270 in the cost estimation screen 200, as depicted in FIG. 2. Upon selection of the analysis button 270, the cost estimation tool 10 takes the user to an alternative display, depending on patient type status 120 defined in the data collection screen 100.

If the patient's costs are covered by a MCO, a variety of MCO reimbursement profiles can be established to evaluate reimbursement at different levels of care. Alternatively, if the patient receives Medicaid, the cost estimation tool 10 may alert the user to Preferred Drug List (PDL) reimbursement issues or other formulary conflicts. Specifically, the PDL is Medicaid's attempt to bring some type of formulary restrictions to traditional Medicaid. The PDL, while not expressly limiting the use of drug, defines drugs that will be reimbursed without agency pre-approval, and drugs not listed on the PDL will not be reimbursed without agency pre-approval. Thus, there is a strong incentive for health care providers and patients to use drugs on the PDL in favor of other drugs. The PDL data is stored in the reimbursement database 5, and the cost estimation tool 10 can identify and note any selected drugs not on the PDL, where a viable option on the PDL is available.

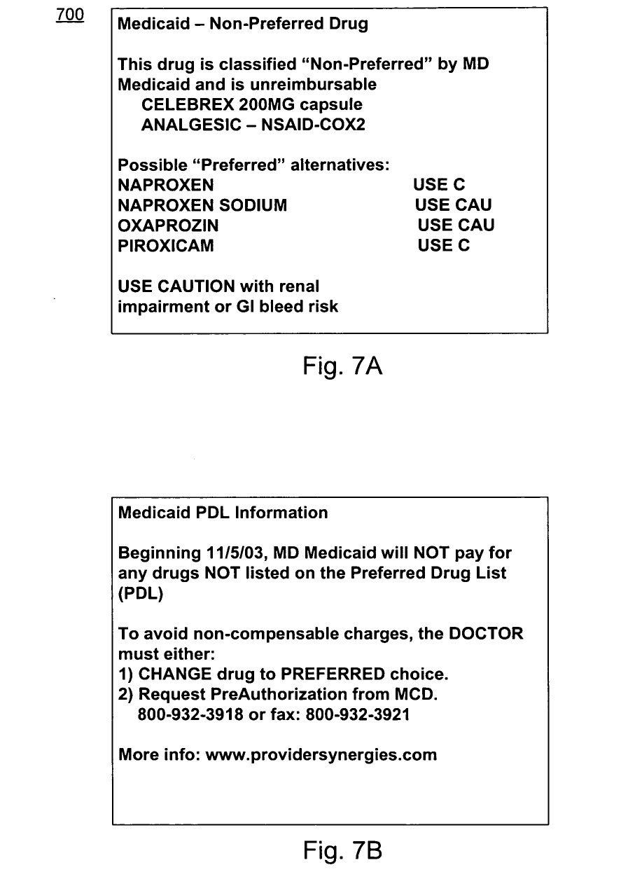

For example, FIG. 7A depicts a Medicaid drug list screen 700 containing a reimbursement information for a user selected drug, such as a drug specified above in the drug definition screen. Specifically, the Medicaid drug list screen 700 indicates whether the specified drug is on the PDL and, therefore, eligible for reimbursement. The Medicaid drug list screen 700 may further list alternative medications on the PDL, as defined in the drug database 5. Further information about the reimbursement information may be displayed in a supplemental drug reimbursement screen 710 in FIG. 7B that explains the reimbursement information. The supplemental drug reimbursement screen 710 may further contain information, such as a contact telephone number, that directs the health care provider 7 to obtain approval for use of the specified drug where the alternatives drugs on the PDL are undesirable or inappropriate.

Where a long-term patient qualifies for Medicare, the health care providers are reimbursed according to Resource Utilization Groups (RUGS) III standards for patient classification and reimbursements for extended-care facilities, such as nursing homes. In RUGs III, the patient is classified according to that patient wellness level and general independence, with sicker patients and patients requiring greater levels of care being eligible for longer duration nursing home care and higher daily reimbursement. RUGs-III includes seven principal patient categories that, through further secondary and tertiary splits, produces a total of 44 patient categories. Many of these splits are defined by the RUG-III ADL (Activities of Daily Living) Index. The seven principal patient categories are defined below in Table 1:

TABLE 1
Principal RUGs III Patient Categories

1. Rehabilitation (Special). Rehabilitation therapy is any
combination of physical, occupational, or speech therapy. This
category is divided into 4 sub-categories defined by the
intensity of care provided to patients, as follows:
Very High Intensity Multidisciplinary Rehabilitation.
450+ minutes of rehabilitation therapy per week, 2+ of
the three therapies provided, with 5+ days per week of
one type of therapy.
High Intensity Rehabilitation. 300+ minutes of
rehabilitation therapy per week, with 5+ days per week
of one type of therapy.
Medium Intensity Rehabilitation. 150+ minutes of
rehabilitation therapy per week, with 5+ days per week
of one type of therapy.
Low Intensity Rehabilitation. 45+ minutes of
rehabilitation therapy per week, with 3+ days per week
of therapy, and 2+ types of nursing rehabilitation.
2. Extensive Services. Patients who have a RUG-III ADL Index
score of at least 7 and who meet at least one of the following
criteria: parenteral feeding, suctioning, tracheostomy,
ventilator/respirator.
3. Special Care. Patients who have a RUG-III ADL Index score of
at least 7 and at least one of the following: burns, coma, fever
(with vomiting, weight loss, pneumonia, or dehydration),
multiple sclerosis, pressure ulcers (stage 3 or 4),
quadriplegia, septicemia, IV medications, radiation treatment,
tube feeding.
4. Clinically Complex. Patients who meet at least one of the
following criteria: aphasia, aspirations, cerebral palsy,
dehydration, hemiplegia, internal bleeding, pneumonia, stasis
ulcer, terminal illness, urinary tract infection, chemotherapy,
dialysis, 4+ physician visits per month, respiratory or oxygen
therapy, transfusions, wound care other than pressure ulcer care
(including active foot care dressings); or patients meeting the
criteria for the Extensive Services or Special Care categories
but with RUG-III Index scores of 4-6.
5. Impaired Cognition. Patients with a RUG-III ADL Index score
of 4 to 10 who have cognitive impairment in all three of the
following dimensions: decision-making (not independent),
orientation (any problem recalling current season, location of
own room, staff names or faces, that he/she is in a nursing
home, etc.), short-term memory.
6. Behavior Problems. Patients with a RUG-III ADL Index score of
4 to 10 who display daily problems with: inappropriate behavior,
physical abuse, verbal abuse, wandering; or with hallucinations.
7. Physical Functions (Reduced). Patients who do not meet the
conditions of any of the earlier categories, including those who
would meet the criteria for the Impaired Cognition or Behavior
Problems categories but have a RUG-III ADL Index score of 11 or
more.

Six primary activities of daily living (ADLs) are typically used to determine patients' need for long-term care: eating, toileting, transferring, bathing, dressing and continence. However, RUGs researchers found that only 3 plus a newly created ADL (bed mobility) are the only statistically significant predictors of the cost of long-term care. Thus, the RUG-III ADL Index is based on a patient's ability to perform each of these four ADLs, as described in Table 2 below, and the patient's ADL Index is the sum of the scores for all four categories.

TABLE 2
ADLs and Categories of Functional Capability Score

| ADL | Score |
|---|---|
| 1. Bed Mobility: | |
| a. Independent or supervision | 1 |
| b. Limited assistance | 3 |
| c. Extensive assistance or total dependence, | 4 |
| requires only one person for physical assistance | |
| d. Extensive assistance or total dependence, | 5 |
| requires two or more persons for physical | |
| assistance | |
| 2. Transferring: | |
| a. Independent or supervision | 1 |
| b. Limited assistance | 3 |
| c. Extensive assistance or total dependence, | 4 |
| requires only one person for physical assistance | |
| d. Extensive assistance or total dependence, | 5 |
| requires two or more persons for physical | |
| assistance | |
| 3. Toileting: | |
| a. Independent or supervision | 1 |
| b. Limited assistance | 3 |
| c. Extensive assistance or total dependence, | 4 |
| requires only one person for physical assistance | |
| d. Extensive assistance or total dependence, | 5 |
| requires two or more persons for physical | |
| assistance | |
| 4. Eating: | |
| a. Independent or supervision | 1 |
| b. Limited assistance | 2 |
| c. Extensive assistance or total dependence | 3 |
| (including feeding tubes or parenteral feeding) | |

Other variables are also used to create the 44 RUG-III patient categories. These are described in Table 3 below.

TABLE 3
Other RUGs Factors

Extensive Treatment Count
A count of the following extensive treatments (Extensive
Services category): parenteral feeding, suctioning,
tracheostomy, ventilator/respirator.
Depressed Mood (Sad)
Signs and symptoms of a depressed state or sad mood (tertiary
split for the Clinically Complex category). This is a defined
as a persistent sad or anxious mood together with at least 2
of the followIng symptoms.
a. Expressions of distress.
b. Agitation or withdrawal.
c. Early awakening with unpleasant mood or awake only 7
hours per day.
d. Thoughts of death or suicidal thoughts.
e. Weight loss.

Nursing rehabilitation activities are used as a tertiary split for the Impaired Cognition, Behavior Problems, and (Reduced) Physical Functions categories and as a criteria for the Low Intensity Rehabilitation category if at least two of the following activities occur five or more days per week: amputation care, active range of motion, passive range of motion, splint/-brace assistance, dressing/grooming training, eating/swallowing training, locomotion/mobility training, transfer training, and except for the Low Intensity Rehabilitation category, any toileting program.

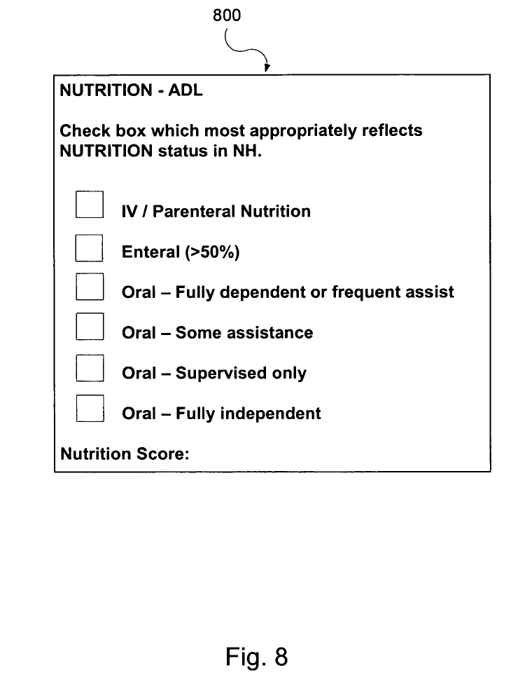

Referring now back to FIG. 5, a Medicare reimbursement display 500 contains one or more RUGs classifications 510. The user may select one of the RUGs classifications 510 for the patient, based upon the user's own skill and experience. Preferably, the user can select the Rug Estimate button 520 to bring up a RUG classification screens as described below in FIGS. 8-15 that walks the user through a series of questions about the patient's performance of the ADLs and other aspects of the RUGs classifications. Various RUGS estimation applications are known and may be employed within the present invention. For example, Accu-Care® software produced by Accu-Med Services, Inc. of Milford, Ohio includes functionality for patient assessment and RUGs level estimation. To assist the user in identifying the most likely level of Medicare reimbursement under the Prospective Payment System (PPS), a RUGs Estimator asks the user some basic questions about resident care. At the earliest possible opportunity, the estimator alerts the user when there is sufficient information to determine a RUGs III reimbursement level. After acknowledging the alert, the analysis screen 500 will return with the appropriate RUGs domain checked.

After the user specifies one of the check boxes corresponding the RUGs classifications 510 or otherwise defines a RUGs classification for the patient, an associated reimbursement amount 530 is displayed. Various fixed costs 540 and the drug costs 550 and then subtracted from the reimbursement amount 530 to determine the health care facility's daily profitability 560 from the patient. Furthermore, the Medicare reimbursement display 500 may include a background section 580 that changes colors or otherwise provides a visual warning if the health care facility will lose money on the patient. A potential saving value 570 includes cost reduction possible by altering the drug list defined above in the displays 200 and 300. In this way, a user can determine the expected profitability/loss from a patient and take steps to change medicine or dosage regiments as needed to ensure profits from the patient.

Turning now to FIG. 6, a managed care classification screen 600 may indicate the expected costs and reimbursement amounts available to a patient depending on the user's managed care plan. For example, FIG. 6 depicts a user classification screen 600 having 2 different levels of care, L1 and L2, and enumerates the different reimbursements levels available for each level of care. The user classification screen 600 further breaks down the reimbursement amounts available for the patient in different categories, such as supplies, labs, drugs, rehabilitation, etc. The user classification screen 600 may include some type of indication, such as a change of background color, to alert the user that the patient's coverage may not sufficiently cover the expected costs.

Turning now to FIGS. 8-15, screen displays 800-1500 are depict the operation of a RUGs estimator 8 in accordance with a preferred implementation of the present invention. As described above, the RUGs estimator 8 walks a user through a series of questions as needed to classify a patient according to the RUGs III Patient Categories, such as the principle categories and the sub-categories described above in Tables 1-3. Specifically, the Medicare reimbursement for a long-term patient is determined by RUG III that evaluates a 412 element documentation form, known as the Minimum Data Set (MDS) that the facility completes and sends electronically to Medicare. Based on a Federal algorithm, certain elements of the MDS are used to calculate the RUG level and subsequently, the amount of payment for care. The RUGs Estimator 8 takes the user through the algorithm-specific elements only in a very rapid and efficient manner and an ESTIMATED RUG III group is calculated. This feature gives the user a rapid assessment of the expected reimbursement for care, which can be balanced with the cost of care. For ease to the user, the multiple possible Medicare RUGS may be consolidated by the RUGs estimator 8 into 9 categories as described above in Medicare costs estimation screen 500.

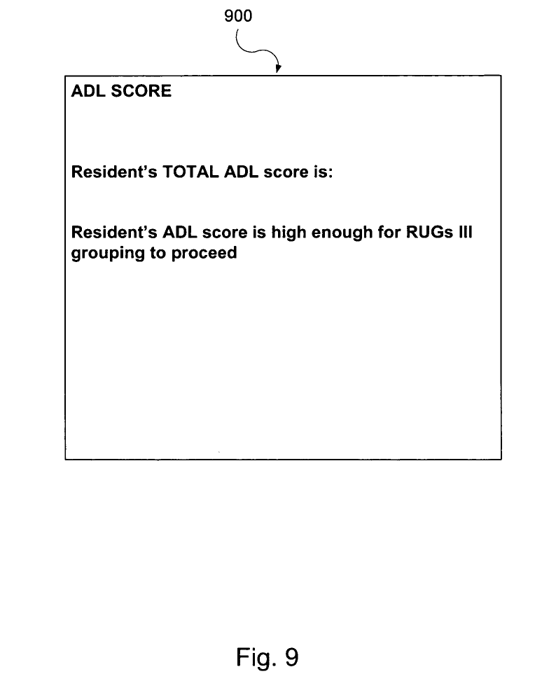

Turning now to FIGS. 8-15, the user provides answers to various answers as needed to determine the patients relative ability to perform various activities of daily living (ADLs), such as dressing, bathing, eating, walking, communication, etc. Under Medicare, a patient received increased funding according to the patients relative ability to perform these functions. Patients having relatively low ability to perform the ADLs require increased levels of care, and are consequently, need more expensive health care. For example, nutrition ADL screen 800 in FIG. 8 asks the user to specify the relative ability of the patient to eat, and the patient is scored. Other screens may similarly address other ADLs abilities. A composite score from the various ADL measurements is tallied and displayed in an ADL scoring screen 900 in FIG. 9.

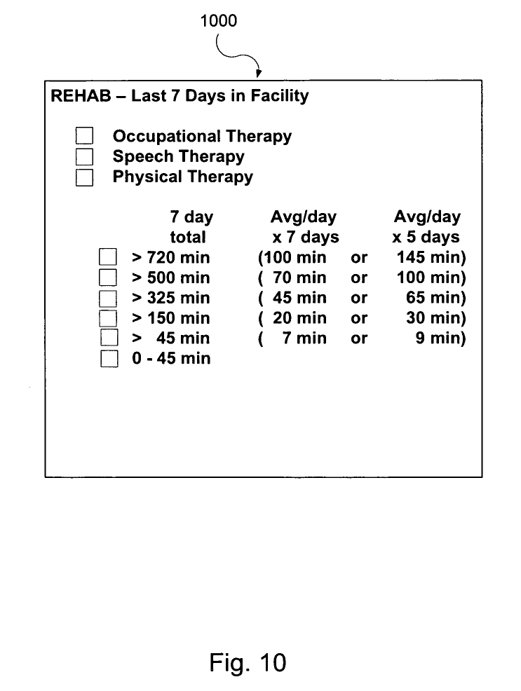

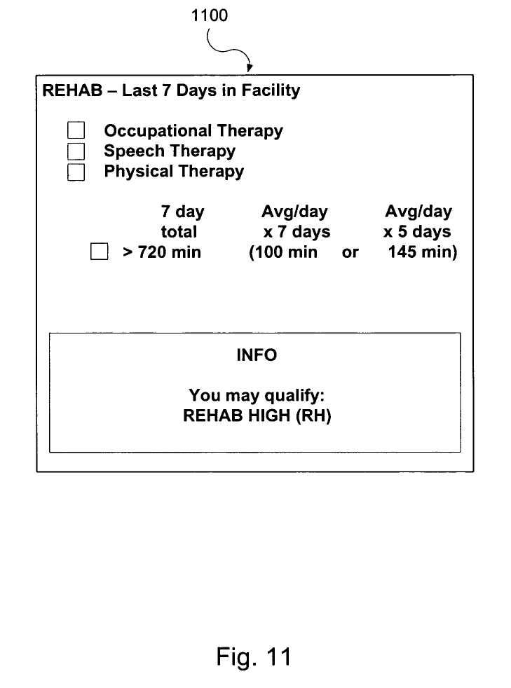

Turning now to FIG. 10, the user may further specify how much physical rehabilitation (or rehab) is required by the patient in physical rehabilitation screen 1000. This users inputs to the physical rehabilitation screen 1000 provide a strong suggestion of the patients relative abilities in several ADLs, such as walking bathing, and dressing. As depicted in FIG. 11, a modified physical rehabilitation screen 1100 may show implications from a users selection made in the physical rehabilitation screen 1000.

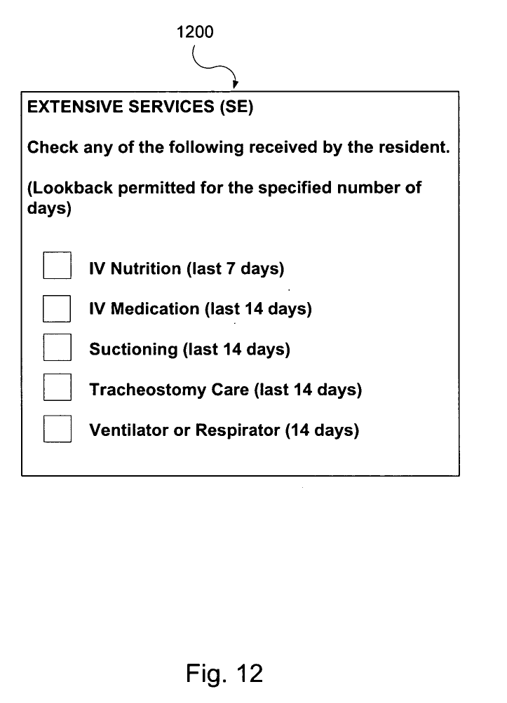

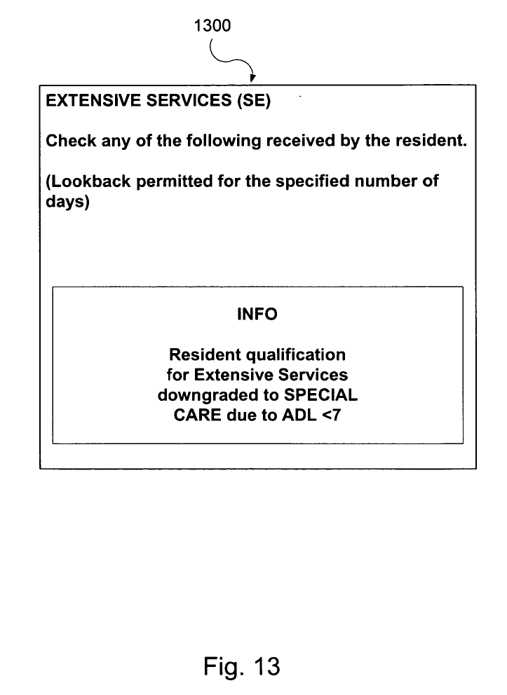

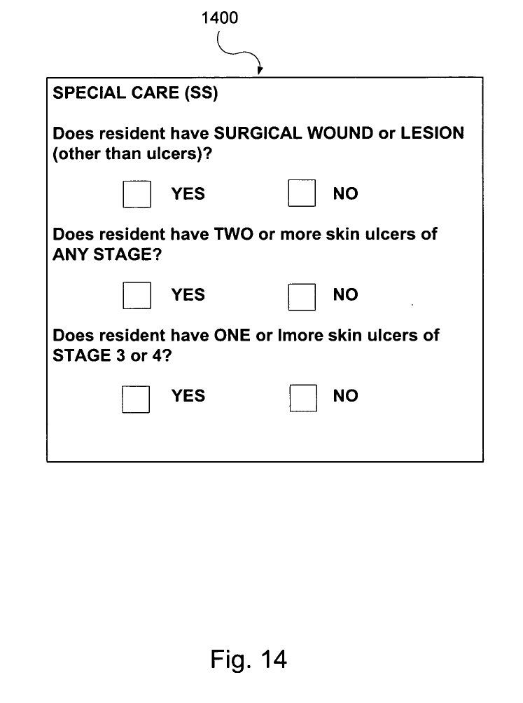

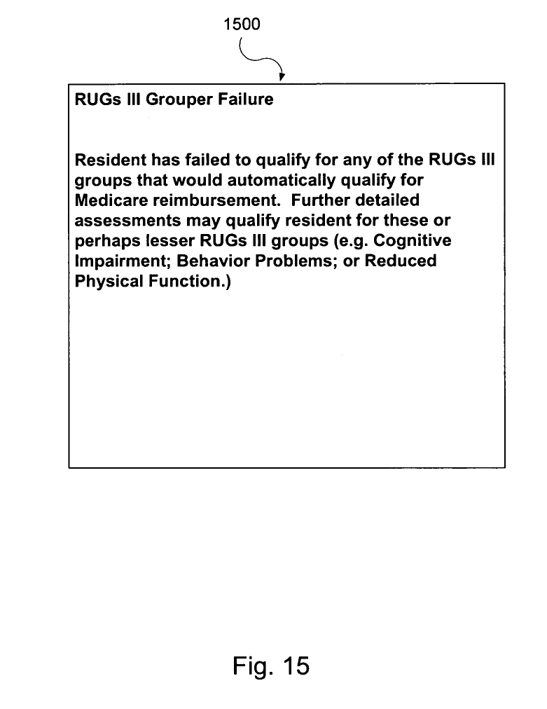

The user may further specify any extensive services recently received or currently needed by the patient in an extensive services screen 1200 of FIG. 12. As with other screens in the RUGs estimator 8, a modified extensive services screen 1300 of FIG. 13 may show the implications to the RUGS estimator 8 from the user's selection in the extensive services screen 1200. Similarly, the user may further specify any special care recently received or currently needed by the patient in a special care screen 1400 of FIG. 14.

Where the patient does not neatly qualify for any the RUGs classification groups with the information provided by the user, a RUGs estimation warning screen 1500 shown in FIG. 15, may indicate to the user additional information needed for the RUGs estimation tool 8 or may otherwise specify that the patient cannot be classified using the RUGs estimation tool 8.

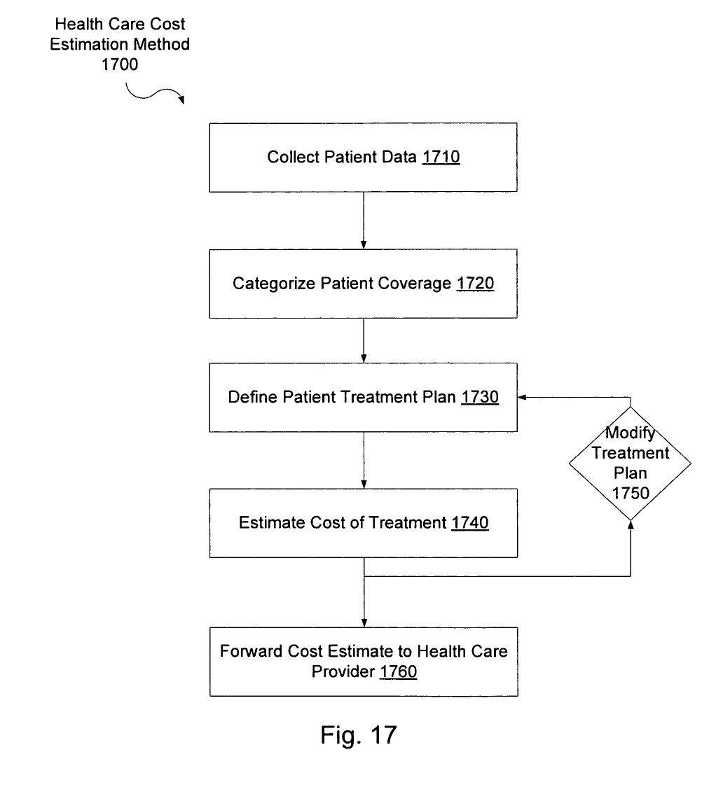

Turning now to FIG. 17, a preadmission cost method 1700 is now presented. Specifically, the preadmission cost method 1700 starts with collecting patient data in step 1710. The collection of patient data may proceed as described above in patient data collection screen 100 in FIG. 1, where the user enters personal data and other information about the user. Otherwise, the user may collect information on the patient's prior care, current ailments, and generally physical condition. For example, the user may collect information on the patients ADL levels. The user may further specify the patient's care provider in step 1710.

Next, the patient data and other information is used to determine the patient's reimbursement levels in step 1720. With a health care plan, the benefits may be predefined, and the patient data from step 1710 is used to determine the patient's level of coverage. Similarly, if it is determined from the patient data acquired in step 1710 that the patient is covered by Medicaid, corresponding PDL information may be defined. Where the patient is covered by Medicare, a long-term care patient may by categorized by RUGs classification using the patient data acquired in step 1710, as described above.

Next, the user may define a course of treatment for the patient in step 1730. Typically, the user specifies expected drug regimens, as described above FIGS. 2-4 and the accompanying text. For example, the user may select a drug from a listing of medicines, and then specify treatment duration and amount.

This predicted course of treatment defined in step 1730 is then priced in step 1740 using the reimbursement coverage defined in step 1720. Typically, this estimate identifies non-covered treatments and specifies the costs for these non-covered treatments. Alternatively, the estimate may tally the cost for treatment and compare this cost with applicable total or daily reimbursements. Accordingly, this allows the user to determine costs to the patient prior to admission.

In step 1750, the user may return to step 1730 to modify the course of treatment and to reprice the modified course of treatment in step 1740. In this way, the user may determine changes in costs to the patient resulting from different treatment selections.

Subsequently, the data from steps 1710-1750 may be forwarded to the patient's care provider in step 1760 so that it may be used during the administering of care. The estimate will have little value if the collected reimbursement data is not used. For example, if it is determined that a drug is not covered by insurance, the health care provider should have this information when determining a desirable course of treatment.

### CONCLUSION

The foregoing description of the preferred embodiments of the invention has been presented for the purposes of illustration and description. It is not intended to be exhaustive or to limit the invention to the precise form disclosed. Many modifications and variations are possible in light of the above teaching. For instance, the method of the present invention may be modified as needed to incorporate new communication networks and protocols as they are developed. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed:

1. A method for estimating treatment costs for patient, the method comprising the steps of:
collecting patient data and storing the patient data on a computer;
the computer defining reimbursement coverage using collected patient data;
defining a course of treatment using collected patient data and storing the course of treatment on the computer; and
the computer pricing the course of treatment using reimbursement data,
wherein said steps of collecting patient data, defining reimbursement coverage, defining a course of treatment, and, pricing the course of treatment occur prior to admission.

2. The method of claim 1 further comprising the step of the computer forwarding the course of treatment and the course of treatment pricing to a health care provider.

3. The method of claim 1, wherein the step of defining reimbursement coverage comprises determining the patient's eligibility for at one of health insurance, Medicare, and Medicaid.

4. The method of claim 3, wherein the patient is eligible for Medicaid, and wherein the step of defining reimbursement coverage comprising identifying a preferred drug list (PDL).

5. The method of claim 3, wherein the step of defining reimbursement coverage comprising identifying a Medicare Resource Utilization Group (RUG) for the patient.

6. The method of claim 5, wherein the step of collecting patient data comprises scoring the patient in one or more activities of daily living (ADLs), whereby said scoring is used to identify the RUG for the patient.

7. The method of claim 1, wherein the step of defining a course of treatment comprises specifying a regimen including one or more drugs.

8. The method of claim 1 wherein the step of defining a course of treatment comprises defining a first course of treatment, wherein the step of pricing the course of treatment comprises pricing the first course of treatment, and wherein the method further comprises the steps of:
modifying the first course of treatment to define a second course of treatment;
the computer pricing the second course of treatment; and
the computer comparing the price for the first course of treatment and the price for the second course of treatment.

9. A data storage medium containing a computer-executable set of instructions for estimating patient costs, the set of instructions implementing a process comprising:
collecting patient data;
defining reimbursement coverage using collected patient data;
defining a course of treatment using collected patient data; and
pricing the course of treatment using reimbursement data,
wherein said steps of collecting patient data, defining reimbursement coverage, defining a course of treatment, and, pricing the course of treatment occur prior to admission.

10. The data storage medium of claim 9 wherein the process further comprises the step of the computer forwarding the course of treatment and the course of treatment pricing to a health care provider.

11. The data storage medium of claim 9, wherein the step of defining reimbursement coverage comprises determining the patient's eligibility for at one of health insurance, Medicare, and Medicaid.

12. The data storage medium of claim 11, wherein the step of defining reimbursement coverage comprising designating the patient as eligible for Medicaid and identifying a preferred drug list (PDL).

13. The data storage medium of claim 12, wherein the step of defining a course of treatment comprises specifying a proposed regimen including one or more drugs, and wherein the process further comprises the steps of:
determining whether the proposed regimen conforms with the PDL;
and for a non conforming regimen, proposing an alternative regimen conforming with the PDL.

14. The data storage medium of claim 11, wherein the step of defining reimbursement coverage comprising identifying a Medicare Resource Utilization Group (RUG) for the patient.

15. The data storage medium of claim 14, wherein the step of collecting patient data comprises scoring the patient in one or more activities of daily living (ADLs), whereby said scoring is used to identify the RUG for the patient.

16. The data storage medium of claim 9, wherein the step of defining a course of treatment comprises specifying a regimen including one or more drugs.

17. The data storage medium of claim 9, wherein the step of defining a course of treatment comprises defining a first course of treatment, wherein the step of pricing the course of treatment comprises pricing the first course of treatment, and wherein the process further comprises the steps of:
modifying the first course of treatment to define a second course of treatment;
the pricing the second course of treatment; and
comparing the price for the first course of treatment and the price for the second course of treatment.

18. A preadmission patient cost estimation tool comprising:
an input device for specifying patient data and a course of treatment prior to patient admission;
a first logic for defining a patient coverage category by comparing said patient data to a coverage database containing eligibility rules for one or more coverage categories and reimbursement rules associated with each of said coverage categories;
a second logic for pricing the course of treatment using the reimbursement rules for the defined patient coverage category; and
a patient data database for storing said patient data, said course of treatment, said defined patient coverage category, and said pricing for the course of treatment.

19. The preadmission patient cost estimation tool of claim 18 further comprising a network connected to said patient database, wherein said network allows a health care provider to access said patient database.

20. The preadmission patient cost estimation tool of claim 18, wherein the coverage categories comprises at one of private health insurance, Medicare, and Medicaid.

21. The preadmission patient cost estimation tool of claim 20, wherein the patient coverage category is Medicaid, and wherein the associated reimbursement rules identify a preferred drug list (PDL).

22. The preadmission patient cost estimation tool of claim 21, wherein the defined course of treatment comprises a proposed regimen including one or more drugs, and wherein the tool further comprises logic for determining whether the proposed regimen conforms with the PDL and for proposing an alternative regimen conforming with the PDL.

23. The preadmission patient cost estimation tool of claim 18, wherein the first logic for defining a patient coverage identifies a Medicare Resource Utilization Group (RUG) for the patient.

24. The preadmission patient cost estimation tool of claim 23, wherein the first logic further comprises a RUGS estimation tool.

25. The preadmission patient cost estimation tool of claim 24, wherein the RUGS estimation tool scores the patient in one or more activities of daily living (ADLs) using the patient data, wherein said scoring is used to identify the patient RUG.

26. The preadmission patient cost estimation tool of claim 18, wherein the course of treatment comprises a regimen including one or more drugs.

27. The preadmission patient cost estimation tool of claim 18, wherein:
the course of treatment comprises first course of treatment,
the pricing of the course of treatment comprises pricing of the first course of treatment,
the input device is used to define a second course of treatment;
the second logic prices the second course of treatment using the reimbursement rules for the defined patient coverage category, and
the second logic compares the price for the first course of treatment and the price for the second course of treatment.
